(19) United States
(12) Patent Application Publication
(10) Pub. No.: US 2018/0370293 A1
(43) Pub. Date: Dec. 27, 2018

(54) Tire Tread For An Agricultural Vehicle

(71) Applicant: COMPAGNIE GENERALE DES ETABLISSEMENTS MICHELIN, Clermont-Ferrand (FR)

(72) Inventors: Patrick VERVAET, Clermont-Ferrand Cedex 9 (FR); Istvan MATYAS, Clermont-Ferrand Cedex 9 (FR); Bruno CHARASSON, Clermont-Ferrand Cedex 9 (FR); Marc GANDILLET, Clermont-Ferrand Cedex 9 (FR); Olivier ROPARS, Clermont-Ferrand Cedex 9 (FR)

(21) Appl. No.: 16/062,704

(22) PCT Filed: Dec. 14, 2016
(86) PCT No.: PCT/FR2016/053426

§ 371 Date: Jun. 15, 2018

(30) Foreign Application Priority Data
Dec. 15, 2015 (FR) 1562380

(51) Int. Cl. B60C 11/03

(52) U.S. Cl. CPC B60C 11/0316; B60C 2200/08; B60C 2011/0313

(57) ABSTRACT

Tire (1) for an agricultural vehicle and more particularly to the tread (2) thereof. The tread has a radial thickness Hₘₐₓ and comprises a middle part (20) and two lateral parts (21, 22), the meridian profile (P_{S}) of the radially outer surface (31, 32) of each lateral part (21, 22) is radially on the inside of the meridian profile (P_{C}) of the radially outer surface (30) of the middle part (20) and the radial distance (d) between the midpoint (I₁, I₂) of the meridian profile (P_{S}) of the radially outer surface (31, 32) of each lateral part (21, 22) and the meridian profile (P_{C}) of the radially outer surface (30) of the middle part (20) is at least equal to 0.5 times the radial thickness Hₘₐₓ of the tread (2).

The subject of the present invention is a tire for an agricultural vehicle, such as a tractor or an agri-industrial vehicle. The subject of the invention is more particularly an agricultural tire, intended to be subjected to a torque, and, concerns more particularly, its tread, intended to come into contact with the ground via a tread surface.

An agricultural tire is intended to run over various types of ground such as the more or less compacted soil of the fields, unmade tracks providing access to the fields, and the tarmac surfaces of roads. Bearing in mind the diversity of use, in the fields and on the road, an agricultural tire and, in particular, the tread thereof needs to offer a performance trade-off that varies according to use. During use in the field, the target performance aspects are essentially effective traction capability, light compaction of the ground and low resistance to forward travel. During road use, the target performance aspects are effective speed capability, low resistance to forward travel, and good roadholding.

It is known that a lever essential to managing the performance trade-off for an agricultural tire subjected to a given load is the pressure to which it is inflated.

In the case of use in the field, on ground that may be more or less loose, it is recommended that the tire be inflated to the lowest possible pressure that does not compromise its endurance. This is because it is known that the lower the inflation pressure, the less the ground will be compacted as the agricultural vehicle passes over, and this will improve the agronomic yield of the crops. In addition, a low inflation pressure reduces rutting, and this is beneficial in terms of the resistance to forward travel of the vehicle.

In the case of use on a track or on a road, on hard ground, for the purpose either of driving the agricultural vehicle outside of its work zone or of transporting products entering or leaving the farm, a higher pressure is needed, particularly to guarantee good roadholding and low rolling resistance.

From a standards-compliance viewpoint, the recommended pressure level is defined, for example, by the standards of the European Technical Rim and Tire Organization (ETRTO) which define curves that give the maximum load and the recommended pressure, as applied to the tire, depending on the speed of the vehicle. By way of example, for a given load, some agricultural tires can operate at pressures below 1 bar, while other tires of the same size operate above 1.6 bar. These differences in operating points are catered for in the standards by overload rating indices (IF or VF, according to the ETRTO standards).

A currently strong trend in the definition of agricultural vehicles of the agricultural tractor type is to incorporate into the operation of these agricultural tractors a dynamic system for managing the tire inflation pressure, commonly referred to as a remote inflation system, so that the tire inflation pressure can be adapted to suit the use.

In one mode of operation at pressure regulated during use, operation in the fields, at low pressure, will thus alternate with operation on the road, at higher pressure. It is known that at low pressure, the contact patch in which the tire tread is in contact with the ground is rather wide and the load applied to the tire is reacted essentially by the edges, or lateral parts, of the tread, whereas at higher pressure, the contact patch in which the tire tread is in contact with the ground is somewhat narrow and the load applied to the tire is reacted essentially by the centre or middle part of the tread. In other words, at low pressure, the contact pressures are at a maximum in the lateral parts of the tread whereas at higher pressure, the contact pressures are at a maximum in the middle part of the tread.

In what follows, and by definition, the circumferential, axial and radial directions refer respectively to a direction tangential to the tread surface of the tire and oriented in the direction of rotation of the tire, to a direction parallel to the axis of rotation of the tire, and to a direction perpendicular to the axis of rotation of the tire. “Radially inside” or, respectively, “radially outside” means “closer to” or, respectively, “further away from the axis of rotation of the tire”. “Axially inside” or, respectively, “axially outside” means “closer to” or, respectively, “further away from the equatorial plane of the tire”, the equatorial plane of the tire being the plane passing through the middle of the tread surface of the tire and perpendicular to the axis of rotation of the tire.

The tread of a tire for an agricultural tractor generally comprises a plurality of lugs. The lugs are elements that are raised with respect to a surface of revolution about the axis of rotation of the tire, known as the bottom surface.

A lug generally has an elongate parallelepipedal overall shape made up of at least one rectilinear or curvilinear portion, and is separated from the adjacent lugs by grooves. A lug may be made up of a succession of rectilinear portions, as described, for example, in documents U.S. Pat. No. 3,603,370, U.S. Pat. No. 4,383,567, EP 795427 or may have a curvilinear shape, as set out in documents U.S. Pat. No. 4,446,902, EP 903249, EP 1831034.

A lug usually, but not necessarily, has a mean angle of inclination with respect to the circumferential direction of close to 45°. This is because this mean angle of inclination in particular allows a good trade-off between traction in the field and vibrational comfort. Traction in the field is better if the lug is more axial, that is to say if its mean angle of inclination with respect to the circumferential direction is close to 90°, whereas vibrational comfort is better if the lug is more circumferential, that is to say if its mean angle of inclination with respect to the circumferential direction is close to 0°. It is a well-known fact that traction in the field is more greatly determined by the angle of the lug in the shoulder region, and this has led certain tire designers to offer a very curved lug shape, leading to a lug that is substantially axial at the shoulder and substantially circumferential in the middle of the tread.

The tread of a tire for an agricultural tractor generally comprises two rows of lugs as described above, these exhibiting symmetry with respect to the equatorial plane of the tire. This distribution of lugs which are inclined with respect to the circumferential direction gives the tread a V shape commonly referred to as a chevron pattern. There is usually a circumferential offset between the two rows of lugs, resulting from one half of the tread being rotated about the axis of the tire with respect to the other half of the tread. Furthermore, the lugs may be continuous or discontinuous and may be circumferentially distributed with a spacing that is either constant or variable.

In general, a person skilled in the art defines the tread of a tire using two important design features: the total width and the voids volume ratio of the tread.

The total width of the tread is the axial distance between the axial ends of the tread surface, these being symmetrical with respect to the equatorial plane of the tire. From a practical standpoint, an axial end of the tread surface does not necessarily correspond to a point that is clearly defined. The knowledge that the tread is delimited externally, on the one hand, by the tread surface and, on the other hand, by two surfaces where it meets two sidewalls that connect the said tread to two beads intended to provide the connection to a mounting rim, an axial end can therefore be defined mathematically as being the orthogonal projection, onto the tread, of a theoretical point of intersection between the tangent to the tread surface in the axial end zone of the tread surface and the tangent to the tread surface in the radially outer end zone of the connecting surface. The total width of the tread corresponds substantially to the axial width of the contact surface when the tire is subjected to the recommended load and pressure conditions.

The voids volume ratio of the tread is defined as being the ratio between the total volume of the grooves that separate the raised elements and the total volume of the tread assumed to be free of voids, comprised radially between the bottom surface and the tread surface. The bottom surface is defined as being the surface translated from the tread surface radially inwards over a radial distance corresponding to the maximum radial depth of the grooves, referred to as the radial thickness Hₘₐₓ of the tread. The voids volume ratio thus implicitly defines the volume of elastomer material of which the tread is made that is intended to become worn. It also has a direct impact on the contact patch over which the tread is in contact with the ground and, therefore, on the contact pressures for contact with the ground, both of which govern tire wear.

The design features of lugged treads of the prior art do not currently allow a satisfactory trade-off to be reached between performance in terms of field use, such as traction capability and resistance to forward travel, and performance in terms of road use, such as wearing life and rolling resistance.

The inventors have set themselves the objective of improving the trade-off between, on the one hand, traction capability and resistance to forward travel, for use in the field, and, on the other hand, wearing life and rolling resistance, in road use.

This objective has been achieved according to the invention by a tire for a vehicle for agricultural use comprising a tread, intended to come into contact with the ground via a tread surface:

the tread comprising raised elements separated from one another at least in part by grooves running radially towards the outside from a bottom surface as far as the tread surface over a radial height H at least equal to 30 mm and at most equal to the radial thickness Hₘₐₓ of the tread,

the tread having a total width W_{T} measured between two axial ends of the tread surface,

the tread comprising a middle part, symmetrical about an equatorial plane and having a middle width W_{C} at least equal to 5% and at most equal to 25% of the total width W_{T}, and two lateral parts, each extending axially inwards from an axial end of the tread surface and each having a lateral width W_{S} at least equal to 5% and at most equal to 20% of the total width W_{T}.

the middle part comprising a radially outer surface having, in a meridian plane, a meridian profile having a midpoint and a radius of curvature R_{C} at its midpoint, and each lateral part comprising a radially outer surface having a meridian profile having a midpoint and a radius of curvature R_{S} at its midpoint,

the meridian profile of the radially outer surface of each lateral part being radially on the inside of the meridian profile of the radially outer surface of the middle part,

and the radial distance between the midpoint of the meridian profile of the radially outer surface of each lateral part and the meridian profile of the radially outer surface of the middle part being at least equal to 0.5 times the radial thickness Hₘₐₓ of the tread.

The middle part is not necessarily in contact with each lateral part from which it may be separated by an intermediate or transition part. What is meant by the radially outer surface of the middle part or of each lateral part is a surface enveloping the raised elements of the parts in question, discounting the grooves that separate the said raised elements. What is meant by the meridian profile of a radially outer surface is the curve of intersection of the said radially outer surface with any meridian plane containing the axis of revolution of the tire. The radius of curvature at a midpoint of the meridian profile, extending axially between a first and a second limit point, of a radially outer surface is the radius of the circle passing through the midpoint and the two limit points of the meridian profile: it is also referred to as the mean radius of curvature. A meridian profile is an inflated meridian profile, defined for a tire mounted on its recommended rim and inflated to its recommended pressure as defined, for example, by the ETRTO standard or by standard ISO 4251, the tire not being compressed, that is to say not being subjected to any radial load.

According to a first essential feature of the invention, the meridian profile of the radially outer surface of each lateral part is radially on the inside of the meridian profile of the radially outer surface of the middle part. In other words, the meridian profile of the radially outer surface of each lateral part is offset radially towards the inside with respect to the meridian profile of the radially outer surface of the middle part: this creates a depression on each lateral part with respect to the middle part.

According to a second essential feature of the invention, the radial distance between the midpoint of the meridian profile of the radially outer surface of each lateral part and the meridian profile of the radially outer surface of the middle part is at least equal to 0.5 times the radial thickness Hₘₐₓ of the tread. This radial distance quantifies the radial offset between the respective meridian profiles of the radially outer surfaces of the middle part and of each lateral part.

The combination of the essential features of the invention makes it possible in particular to optimize the contact between the tread and a rigid ground of the road surface type at high and at low pressure.

At high pressure, which means to say at an inflation pressure at least equal to ⅔ of the recommended pressure, the radially outer surface of the middle part is fully in contact with the ground, while the radially outer surfaces of the lateral parts are not in contact with the ground, the radially outer surfaces of the intermediate parts between each lateral part and the middle part being in partial contact with the ground. In other words, the tread is in partial contact with the ground, essentially via its middle part, and at least partially via its intermediate parts. For example, for a tire, the recommended pressure of which is equal to 2.4 bar, partial contact is obtained for a pressure at least equal to 1.6 bar.

At low pressure, which means to say at an inflation pressure at most equal to ½ the recommended pressure, the respective radially outer surfaces of the middle part, of the intermediate parts and of the lateral parts are in total contact with the ground. In other words, the tread is fully in contact with the ground. By way of example, for a tire, the recommended pressure of which is equal to 2.4 bar, full contact is obtained for a pressure at most equal to 1.2 bar.

During road use at high pressure, in comparison with a tire of the prior art comprising a lugged tread of conventional meridian profile, with no depression at the lateral parts, the load-bearing is essentially afforded by the middle part of the tread. In particular, in instances in which the middle part is near continuous, the wearing life on roads is increased and the rolling resistance is decreased. In addition, road comfort is improved, in comparison with a lugged tread which induces vibration each time a lug enters or leaves the contact patch.

During field use at low pressure, in comparison with a tire of the prior art, the traction capability on loose or firm agricultural ground is increased thanks to the increase in the width of the tread. In addition, the increase in the width of the tread makes it possible to reduce the extent to which agricultural land is compacted and, in the case of loose ground, makes it possible to reduce the resistance to forward travel.

From a practical standpoint, the automatic transition from high-pressure operation to low-pressure operation and vice versa may advantageously be achieved by a remote inflation system carried on board the agricultural vehicle and allowing management of the pressures to which the various tires with which the vehicle is equipped are inflated.

Advantageously, the radial distance between the midpoint of the meridian profile of the radially outer surface of each lateral part and the meridian profile of the radially outer surface of the middle part is at least equal to 0.7 times the radial thickness Hₘₐₓ of the tread. A greater radial offset accentuates the technical effects described hereinabove.

Advantageously also, the radius of curvature R_{C} at the midpoint of the meridian profile of the radially outer surface of the middle part is at least equal to the radius of curvature R_{S} at the midpoint of the meridian profile of the radially outer surface of each lateral part. Such a ratio between these radii of curvature ensures a flat meridian profile of the tread surface, namely one with a high mean radius of curvature, typically at least equal to 1000 mm, and this makes it easier for the meridian portion of the tread to flatten out on rigid or loose ground, hence increasing the area of contact between the tread and the ground. Such an increase in the area of contact leads, particularly on firm ground, to a reduction in contact pressures and therefore to an increase in the wearing life and, on loose ground, to an increase in traction capability.

More advantageously still, the radius of curvature R_{C} at the midpoint of the meridian profile of the radially outer surface of the middle part is at least equal to 1.1 times, preferably to 1.2 times, the radius of curvature R_{S} at the midpoint of the meridian profile of the radially outer surface of each lateral part. With an even higher mean radius of curvature of the meridian profile of the tread surface, the flattening of the meridian portion of the tread becomes even easier still.

According to one first preferred embodiment, the middle part having a middle voids volume ratio TE_{C} equal to the ratio between the total volume of the grooves separating the raised elements of the middle part and the total volume of the middle part comprised radially between the bottom surface and the tread surface, the middle voids volume ratio TE_{C} is at most equal to 30%, preferably at most equal to 20%. Such a middle voids volume ratio TE_{C} implies that there is a minimal volume of material in contact with the ground in the middle part, ensuring satisfactory wearing and road holding performance. The life with regards to wear is also increased by the rigidity, and therefore the low mobility, of the raised elements of the middle part. The rolling resistance is decreased by the rigidity, and therefore the low mobility, of the raised elements of the middle part.

According to one alternative form of the first preferred embodiment, each lateral part having a lateral voids volume ratio TE_{S} equal to the ratio between the total volume of the grooves separating the raised elements of the lateral part and the total volume of the lateral part comprised radially between the bottom surface and the tread surface, the lateral voids volume ratio TE_{S} is at least equal to 50%, preferably at least equal to 60%. Such a lateral voids volume ratio TE_{S} implies that there is a minimal volume of grooves in the lateral parts, ensuring, in field use, the shearing of a minimum volume of soil, thereby implying a satisfactory traction capability in the field.

According to another alternative form of the first preferred embodiment, the tread comprising two intermediate parts, each intermediate part being axially delimited by the middle part and one lateral part, each intermediate part having an intermediate voids volume ratio TE_{I} equal to the ratio between the total volume of the grooves separating the raised elements of the intermediate part and the total volume of the intermediate part comprised radially between the bottom surface and the tread surface, the intermediate voids volume ratio TE_{I} is at least equal to 50%, and at most equal to 75%. Such an intermediate voids volume ratio TE_{I} implies that there is a minimal volume of grooves in the intermediate parts, ensuring, in field use, the shearing of a minimum volume of soil, thereby implying a satisfactory traction capability in the field.

According to a second preferred embodiment, the raised elements of the middle part and of each lateral part extending radially outwards from the bottom surface out to the tread surface over a radial height H, any raised element of the middle part comprises a first elastomer compound extending radially towards the inside from the radially outer surface over a radial distance at least equal to 0.5 times and at most equal to 1 times the radial height H and any raised element of each lateral part comprises a second elastomer compound extending radially inwards from the radially outer surface over a radial distance at least equal to 0.5 times and at most equal to 1 times the radial height H.

This second preferred embodiment of the invention seeks to obtain differentiation in the performance of the tread between the middle part that is made up at least in part of a first elastomer compound and is intended to resist wear in road use, and the lateral parts that are made up at least in part of a second elastomer compound and are intended to resist attack when used in the field. Consequently, the first and second elastomer compounds are advantageously different.

Because the middle part is the part of the tread that is chiefly subjected to wear, in road use at high pressure, any raised element of the middle part comprises a first elastomer compound extending radially towards the inside from the radially outer surface over a radial distance at least equal to 0.5 times and at most equal to 1 times the radial height H, namely representing 50% to 100% of the radial height H of the raised element, this first elastomer compound advantageously being resistant to wear.

Because the lateral parts are the parts of the tread that are chiefly subjected to attack, in field use at low pressure, any raised element of each lateral part comprises a second elastomer compound extending radially towards the inside from the radially outer surface over a radial distance at least equal to 0.5 times and at most equal to 1 times the radial height H, namely representing 50% to 100% of the raised element, this second elastomer compound advantageously being resistant to attack in field use.

This second preferred embodiment of the invention has been described and claimed in international application WO 2015158871, for a lug tread pattern of agricultural tire. This document in particular describes first and second elastomer compounds for the middle part and the lateral part respectively, on the one hand in terms of their respective complex dynamic shear modulus values G₁* and G₂* at 50% strain and at 60° C., and in terms of their respective loss factors tan (δ₁) and tan (δ₂), and on the other hand in terms of their respective chemical compositions.

As far as the intermediate parts of the tread are concerned, these may comprise, alone or in combination, the first and second elastomer compounds mentioned hereinabove or comprise a third elastomer compound.

The present invention will be better understood with the aid of the appended figures which are schematic and not drawn to scale:

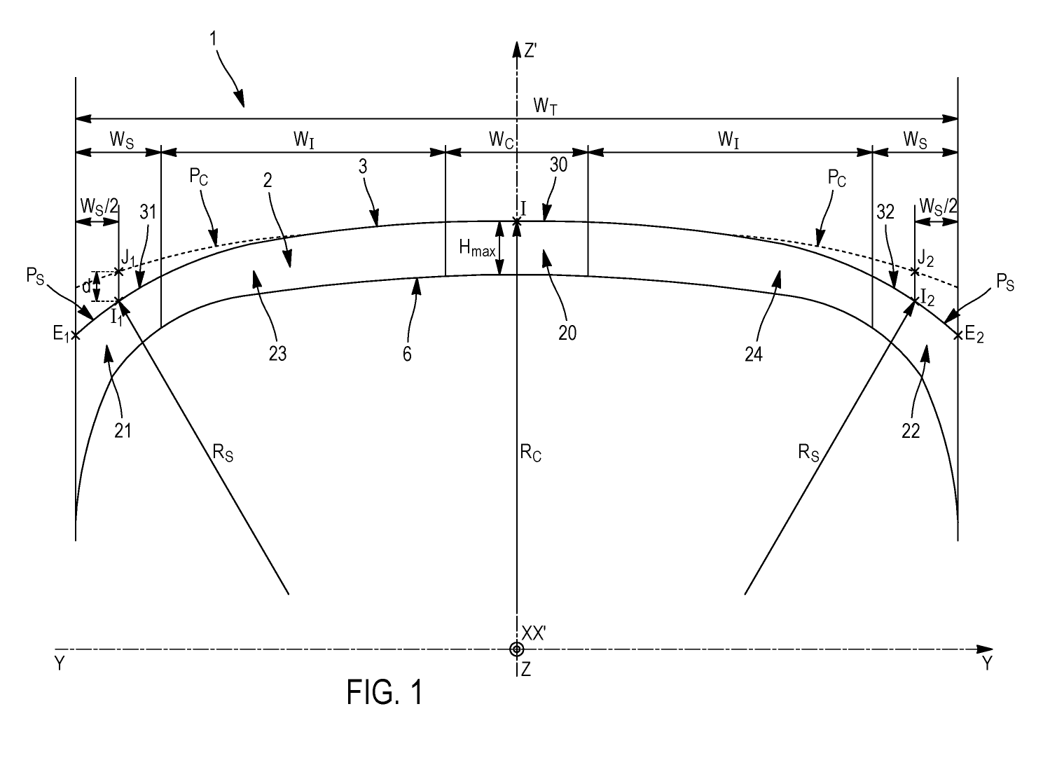

FIG. 1: a meridian section of a tread of a tire according to the invention;

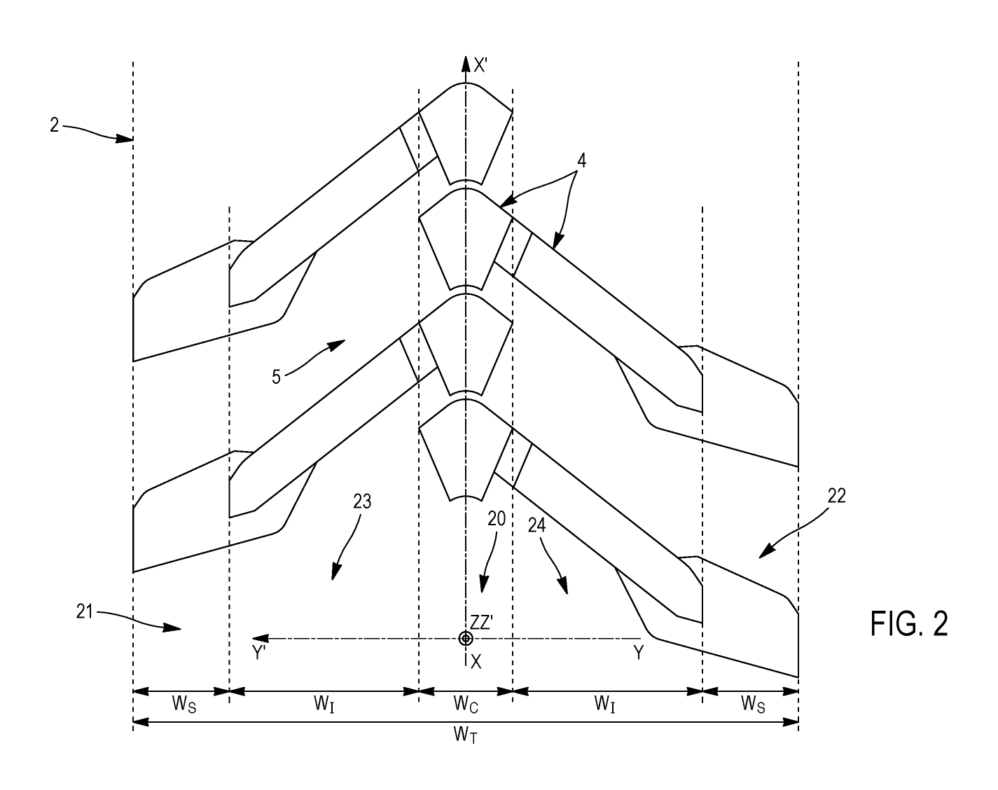

FIG. 2: a plan view of a tread of a tire according to the invention;

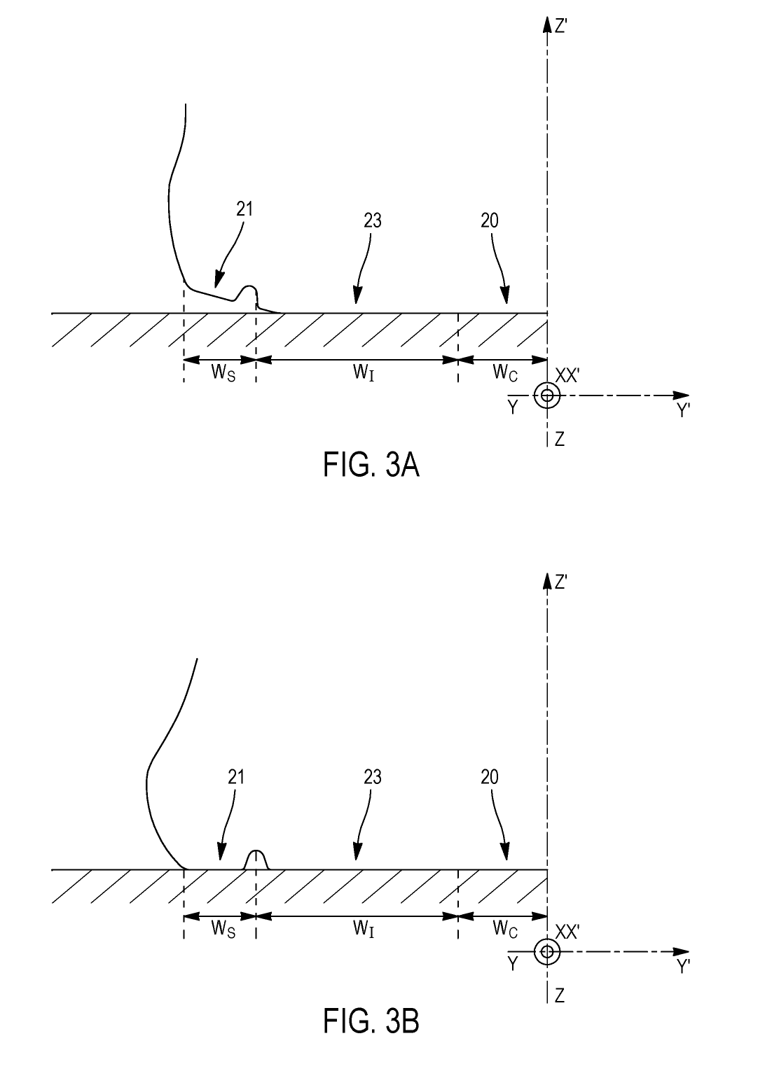

FIG. 3A: a diagram of contact with firm ground of a tire according to the invention used at high pressure;

FIG. 3B: a diagram of contact with firm ground of a tire according to the invention used at low pressure.

FIG. 1 depicts a meridian section, in a meridian plane YZ, of a tire 1 for vehicle for agricultural use, comprising a tread 2 intended to come into contact with the ground via a tread surface 3. The tread 2 comprises raised elements 4 separated from one another at least in part by grooves 5 running radially towards the outside from a bottom surface 6 as far as the tread surface 3 over a radial height H at least equal to 30 mm and at most equal to the radial thickness Hₘₐₓ of the tread 2. The tread 2 has a total width W_{T} measured between two axial ends (E₁, E₂) of the tread surface 3. The tread 2 comprises a middle part 20, symmetrical about an equatorial plane XZ and having a middle width W_{C} at least equal to 5% and at most equal to 25% of the total width W_{T}, and two lateral parts (21, 22), each extending axially inwards from an axial end (E₁, E₂) of the tread surface 2 and each having a lateral width W_{S} at least equal to 5% and at most equal to 20% of the total width W_{T}. The tread further comprises two intermediate parts (23, 24), each intermediate part (23, 24) being axially delimited by the middle part 20 and a lateral part (21, 22). The middle part 20 comprises a radially outer surface 30 having, in a meridian plane YZ, a meridian profile P_{C} having a midpoint I and a radius of curvature R_{C} at its midpoint I. Each lateral part (21, 22) comprises a radially outer surface (31, 32) having a meridian profile P_{S} having a midpoint (I₁, I₂) and a radius of curvature R_{S} at its midpoint (I₁, I₂). According to the invention, the meridian profile P_{S} of the radially outer surface (31, 32) of each lateral part (21, 22) is radially on the inside of the meridian profile P_{C} of the radially outer surface 30 of the middle part 20. Also according to the invention, the radial distance d between the midpoint (I₁, I₂) of the meridian profile P_{S} of the radially outer surface (31, 32) of each lateral part (21, 22) and the meridian profile P_{C} of the radially outer surface (30) of the middle part (20) is at least equal to 0.5 times the radial thickness Hₘₐₓ of the tread (2). More specifically, this radial distance d is measured between the midpoint (I₁, I₂) of the meridian profile P_{S} of the radially outer surface (31, 32) of each lateral part (21, 22) and the point (J₁, J₂), of intersection between the radial straight line of direction ZZ′ passing through the midpoint (I₁, I₂) and the meridian profile P_{C} of the radially outer surface 30 of the middle part 20.

FIG. 2 is a plan view of a tread 2 of a tire according to the invention. The tread 2, of total width W_{T}, comprises raised elements 4 at least partly separated from one another by grooves 5. The tread 2, having a total width W_{T}, comprises a middle part 20 having a middle width W_{C} at least equal to 5% and at most equal to 25% of the total width W_{T}, two lateral parts (21, 22), having a lateral width W_{S} at least equal to 5% and at most equal to 20%, and two intermediate parts (23, 24) having a lateral width W_{I}. In the case depicted, the middle part 20 is near continuous. The intermediate parts (23, 24) are partially connected to the middle part 20 by bridges.

FIGS. 3A and 3B schematically depict contact with firm ground of a tire according to the invention used at high pressure and at low pressure, respectively. In FIG. 3A, in use at high pressure, which means to say at an inflation pressure at least equal to ⅔ of the recommended pressure, the radially outer surface of the middle part of middle width W_{C} is fully in contact with the ground, while the radially outer surfaces of the lateral parts of lateral width W_{S} are not in contact with the ground, the radially outer surfaces of the intermediate parts between each lateral part and the middle part of intermediate width W_{I} being in partial contact with the ground. In other words, the tread is in partial contact with the ground, essentially via its middle part, and at least partially via its intermediate parts. In FIG. 3B, in use at low pressure, which means to say at an inflation pressure at most equal to ½ the recommended pressure, the respective radially outer surfaces of the middle part of middle width W_{C}, of the intermediate parts of intermediate width W_{I} and of the lateral parts of lateral width W_{S} are fully in contact with the ground. In other words, the tread is fully in contact with the ground.

The invention has been studied more particularly in the case of an agricultural tire of size IF 710/70R42.

The design features of the tread of the studied tire according to the invention are set out in Table 1 below.

TABLE 1

| | | |
|---|---|---|
| Total width W_{T} of the tread (mm) | 738 | mm |
| Middle width W_{C} of the middle part (mm) | 106 | mm |
| Lateral width W_{S} of each lateral part (mm) | 236 | mm |
| Intermediate width W_{I} of each intermediate part (mm) | 80 | mm |
| Radial thickness Hₘₐₓ of the tread (mm) | 60 | mm |
| Radial distance d between the respective radially outer | 40 | mm |
| profiles of the middle and and lateral parts (mm) | | |
| Mean radius of curvature R_{C} of the radially outer profile | 1200 | mm |
| of the middle part (mm) | | |
| Mean radius of curvature R_{S} of the radially outer profile | 900 | mm |
| of each lateral part (mm) | | |

| | |
|---|---|
| Middle voids volume ratio TE_{C} (%) | 20% |
| Lateral voids volume ratio TE_{S} (%) | 60% |
| Intermediate voids volume ratio TE_{I} (%) | 75% |

As regards the road-use performance measured on the tire according to the invention described hereinabove, as compared with that of a tire of the prior art, the wearing life, which represents the maximum distance covered, has been increased by 10% and the fuel consumption has been reduced by around 10%, because of the reduction in rolling resistance.

As regards the field-use performance measured on the tire according to the invention described hereinabove, as compared with that of a tire of the prior art, the traction capability, which represents the maximum load that can be pulled, for a given level of tire slip relative to the ground, has been increased by 20% and the fuel consumption has been reduced by around 10%, because of the reduction in resistance to forward travel.

The invention may easily be extrapolated to a tire in which, for example and non-exhaustively:

the tread has a radial thickness Hₘₐₓ of less than 30 mm

the tread comprises a middle part which is not symmetrical about the equatorial plane and/or has intermediate parts with different intermediate widths W_{I} and/or has lateral parts with different lateral widths W_{S}.

1. A fire for a vehicle for agricultural use comprising a tread, adapted to come into contact with the ground via a tread surface:
the tread comprising raised elements separated from one another at least in part by grooves running radially towards the outside from a bottom surface as far as the tread surface over a radial height H at least equal to 30 mm and at most equal to the radial thickness Hₘₐₓ of the tread;
the tread having a total width W_{T} measured between two axial ends of the tread surface;
the tread comprising a middle part, symmetrical about an equatorial plane and having a middle width W_{C} at least equal to 5% and at most equal to 25% of the total width W_{T}, and two lateral parts, each extending axially inwards from an axial end of the tread surface and each having a lateral width W_{S} at least equal to 5% and at most equal to 20% of the total width W_{T};
the middle part comprising a radially outer surface having, in a meridian plane, a meridian profile having a midpoint and a radius of curvature R_{C} at its midpoint, and each said lateral part comprising a radially outer surface having a meridian profile having a midpoint and a radius of curvature R_{S} at its midpoint,
wherein the meridian profile of the radially outer surface of each said lateral part is radially on the inside of the meridian profile of the radially outer surface of the middle part and wherein the radial distance between the midpoint of the meridian profile of the radially outer surface of each said lateral part and the meridian profile of the radially outer surface of the middle part is at least equal to 0.5 times the radial thickness Hₘₐₓ of the tread.

2. The tire according to claim 1, wherein the radius of curvature R_{C} at the midpoint of the meridian profile of the radially outer surface of the middle part is at least equal to the radius of curvature R_{S} at the midpoint of the meridian profile of the radially outer surface of each said lateral part.

3. The tire according to claim 1, wherein the radius of curvature R_{C} at the midpoint of the meridian profile of the radially outer surface of the middle part is at least equal to 1.1 times the radius of curvature R_{S} at the midpoint of the meridian profile of the radially outer surface of each said lateral part.

4. The tire according to claim 1, the middle part having a middle voids volume ratio TE_{C} equal to the ratio between the total volume of the grooves separating the raised elements of the middle part and the total volume of the middle part comprised radially between the bottom surface and the tread surface, wherein the middle voids volume ratio TE_{C} is at most equal to 30%.

5. The tire according to claim 1, each said lateral part having a lateral voids volume ratio TE_{S} equal to the ratio between the total volume of the grooves separating the raised elements of the lateral part and the total volume of the lateral part comprised radially between the bottom surface and the tread surface, wherein the lateral voids volume ratio TE_{S} is at least equal to 50%.

6. The tire according to claim 1, the tread comprising two intermediate parts, each said intermediate part being axially delimited by the middle part and one said lateral part, each said intermediate part having an intermediate voids volume ratio TE_{I} equal to the ratio between the total volume of the grooves separating the raised elements of the intermediate part and the total volume of the intermediate part comprised radially between the bottom surface and the tread surface, wherein the intermediate voids volume ratio TE_{I} is at least equal to 50%, and at most equal to 75%.

7. The tire according to claim 1, the raised elements of the middle part and of each said lateral part extending radially outwards from the bottom surface out to the tread surface over a radial height H, wherein any raised element of the middle part comprises a first elastomer compound extending radially towards the inside from the radially outer surface over a radial distance at least equal to 0.5 times and at most equal to 1 times the radial height H and wherein any raised element of each said lateral part comprises a second elastomer compound extending radially inwards from the radially outer surface over a radial distance at least equal to 0.5 times and at most equal to 1 times the radial height H.

8. The tire according to claim 1, wherein the radius of curvature R_{C} at the midpoint of the meridian profile of the radially outer surface of the middle part is at least equal to 1.2 times the radius of curvature R_{S} at the midpoint of the meridian profile of the radially outer surface of each said lateral part.

9. The tire according to claim 1, the middle part having a middle voids volume ratio TE_{C} equal to the ratio between the total volume of the grooves separating the raised elements of the middle part and the total volume of the middle part comprised radially between the bottom surface and the tread surface, wherein the middle voids volume ratio TE_{C} is at most equal to 20%.

10. The tire according to claim 1, each said lateral part having a lateral voids volume ratio TE_{S} equal to the ratio between the total volume of the grooves separating the raised elements of the lateral part and the total volume of the lateral part comprised radially between the bottom surface and the tread surface, wherein the lateral voids volume ratio TE_{S} is at least equal to 60%.
